(19) United States
(12) Patent Application Publication
(10) Pub. No.: US 2026/0234079 A1
(43) Pub. Date: Aug. 13, 2026

(54) PYROTECHNIC COLORANT PELLETS

(71) Applicant: AMERICAN OUTDOOR BRANDS, Columbia, MO (US)

(72) Inventors: James Tayon, Moberly, MO (US); Tim Kinney, Warrenton, MO (US); Brandon Kelly, Moberly, MO (US); Ian Christopher Siercks, Columbia, MO (US); Todd Strobel, Mokane, MO (US)

(21) Appl. No.: 19/180,854

(22) Filed: Apr. 16, 2025

Related U.S. Application Data
(60) Provisional application No. 63/635,354, filed on Apr. 17, 2024.

(51) Int. Cl. C06B 45/06; C06B 21/00; C06B 23/00; C06B 45/02; C06B 45/08

(52) U.S. Cl. CPC C06B 45/06; C06B 21/0008; C06B 23/00; C06B 45/02; C06B 45/08

(57) ABSTRACT

Methods, systems, and devices for pyrotechnic colorant pellets are described. A pyrotechnic pellet may include a pyrotechnic fuel, such as wood particles, a binder, and one or more metal salts. In some instances, the pyrotechnic pellet may also include a binder. The metal salt(s) may include an element or compound that, when ignited, emits a specific color (or colors). Thus the pyrotechnic pellet, when ignited (e.g., burned), may emit heat and a color associated with the metal salt(s).

### CROSS-REFERENCE TO RELATED APPLICATIONS

This application claims the benefit of U.S. Provisional Patent Application No. 63/635,354, filed Apr. 17, 2024, which is incorporated by reference herein in its entirety.

### TECHNICAL FIELD

The following relates to one or more pyrotechnic fuels, including pyrotechnic colorant pellets.

### DESCRIPTION OF RELATED TECHNOLOGY

Different fuels, such as wood, are sometimes used both for warmth (e.g., burning wood) and adding ambiance to an environment. Wood fires may emit yellow and orange colors (and similar hues) due to the natural materials. In some instances, wood-based fuels may be burned in various forms. For example, wood-based fuels may be burned as firewood (e.g., generally unprocessed). Such fuels may generate heat and emit yellow and orange colors, which may enhance the ambiance of the environment in which they are burned.

### BRIEF DESCRIPTION OF THE DRAWINGS

FIG. 1 shows an example of a pyrotechnic pellet in accordance with examples as disclosed herein.

FIG. 2 shows an example environment in which a pyrotechnic pellet may be used in accordance with examples as disclosed herein.

FIG. 3 shows a flowchart illustrating a method or methods that support the formation of pyrotechnic colorant pellets in accordance with examples as disclosed herein.

FIG. 4 shows an example of one or more pyrotechnic pellets in accordance with examples as disclosed herein.

### DETAILED DESCRIPTION

Wood-based fuels may come in a variety of forms. For example, wood-based fuels may include firewood (e.g., wood in a generally unprocessed form) and other options. In each instance, the fuel may be ignited and may emit heat. That is, a wood-based fuel may be combustible and may be ignited (in a fireplace, a fire pit, or similar setting) to emit heat. In some instances, igniting a wood-based fuel may also enhance the ambiance of the environment in which it is ignited (e.g., burned). For example, the ignited fuel may emit limited color, such as generally yellow and orange hues, which may provide a comforting or otherwise soothing feel to an environment. However, such wood-based fuels may only emit a limited quantity of hues. That is, a wood-based fuel may only specifically emit hues that are natural to the type of fuel (e.g., wood) being burned, whereas a fuel capable of burning in additional colors may provide an enhanced and fun ambiance. Accordingly, a wood-based fuel configured to emit a wide variety of colors may be desirable.

A pyrotechnic fuel configured to emit a wide variety of colors is described herein. In some instances, a pyrotechnic fuel that includes wood particles and one or more metal salts may be formed. Such a fuel may, when ignited (e.g., burned), may emit colors other than the natural hues that a strictly wood-based fuel would emit. That is, different types of metal salts may, when burned, emit colors such as red, gold, green, blue, purple, silver, and white. Accordingly, one or more metal salts may be combined with wood particles and formed into a fuel, such as a pellet (e.g., a pyrotechnic pellet). The pellets can be ignited (e.g., burned) in a variety of settings, such as in a fireplace or in a fire pit, among other settings. When the pellets are burned, they may emit heat and a variety of colors, which may warm the associated environment, while enhancing its ambiance.

Features of the disclosure are illustrated and described in the context of a pyrotechnic pellet and example environment. Features of the disclosure are further illustrated and described in the context of a flowchart.

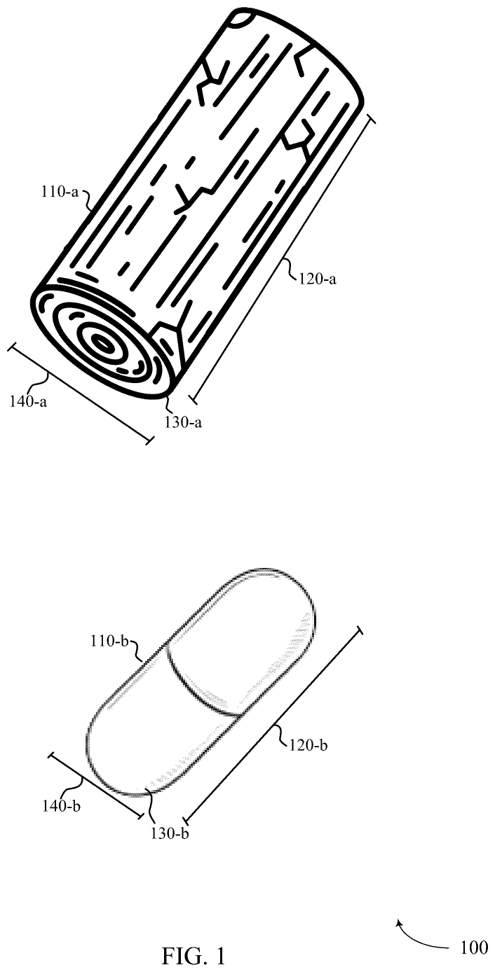

FIG. 1 illustrates an example of a pyrotechnic pellet 100 that supports pyrotechnic colorant pellets in accordance with examples as disclosed herein. In some instances, the pyrotechnic pellet 100 may include one or more metal salts. As described herein, the metal salts may cause the pyrotechnic pellet 100 to emit, when ignited (e.g., burned), colors such as red, gold, green, blue, purple, silver, and white. Thus, the pyrotechnic pellet 100 may be capable of emitting both heat and a variety of colors, which may warm the associated environment, while enhancing its ambiance.

In some instances, the pyrotechnic pellet 100 may be a generally tubular shape (e.g., cylindrical shape) or a generally capsular shape, among other types of shapes. That is, the pyrotechnic pellet 100 may consist of an elongated (e.g., tubular) portion 110 having a length 120. Each end 130 of the elongated portion 110 may be generally circular shaped and may include a diameter 140. In other examples, each end 130 may be a different shape (not shown), such as ovular, square, rectangular, or the like. By way of example, the length 120 may be between one inch (1″) and one and one-half inches (1½″) and the diameter 140 of the ends 130 may be between one-quarter inch (¼″) and five-sixteenths inches ( 5/16″). Such dimensions are, however, for exemplary purposes only and a pyrotechnic pellet 100 may be of any length or any diameter.

The pyrotechnic pellet 100 may in some examples include wood particles, a binder, and one or more metal salts. In some examples, the pyrotechnic pellet 100 may also include an oxidator. The wood particles may consist of food-grade and/or non-food-grade wood particles. The overall amount of the wood particles included in the pyrotechnic pellet 100 may range from 20 wt % to 96 wt %. For example, if the pyrotechnic pellet 100 includes 20 wt % wood particles, it may include approximately 80 wt % of other materials (e.g., a binder, a metal salt). Additionally or alternatively, if the pyrotechnic pellet 100 includes 40 wt % wood particles, it may include approximately 40 wt % of other materials. That is, the sum of the wt % of materials included in the pyrotechnic pellet 100 may be approximately 100 wt %.

For example, a food-grade wood particle may be or may include pure hardwood. As used herein, a hardwood may refer to woods such as oak or hickory that do not include any fillers or additives. Moreover, a non-food-grade particle may include a mix of hardwoods and softwoods, or may include only softwoods. As used herein, a softwood may refer to a wood (or wood-based mixture) that includes bark, leaves, and/or other components (e.g., impurities). Both food-grade and non-food-grade pellets may emit heat when ignited (e.g., burned), but non-food-grade pellets may be relatively less-safe to be used to prepare food items.

In some examples, the pyrotechnic pellet 100 may include a binder, such as a nitrocellulose or PVC. In some instances, the binder may be used to adhere (e.g., attach) the wood particles and the metal salt(s) included in the pyrotechnic pellet 100. The binder may include Nitrogen (N) and may include less than or equal to 14 wt %. In some examples, the binder may include a Nitrogen content in the range of 11 to 13.9% wt %. In some examples, the overall amount of the binder included in the pyrotechnic pellet 100 may range from 2 wt % to 96 wt %. For example, if the pyrotechnic pellet 100 includes 13 wt % binder, it may include approximately 87 wt % of other materials (e.g., wood particles, a metal salt). Additionally or alternatively, if the pyrotechnic pellet 100 includes 10 wt % wood particles, it may include approximately 90 wt % of other materials. That is, the sum of the wt % of materials included in the pyrotechnic pellet 100 may be approximately 100 wt %.

In other examples, the binder may include a starch, an oil, and/or lignin sulfate. Starches, oils, and lignin sulfate may, in addition to and/or alternative to nitrocellulose or PVC, help with pellet binding and may make the pyrotechnic pellet 100 relatively durable and efficient. In some examples, between 1 wt % and 2 wt % of the total mass of the pyrotechnic pellet 100 may be lignin sulfate (e.g., when used as a binder). In other examples, up to 4 wt % of the pyrotechnic pellet 100 may be lignin sulfate. As described herein, lignin sulfate may be a naturally occurring substance in wood, and thus may be a byproduct of forming the pyrotechnic pellet 100. Such binders may be used in pyrotechnic applications due to the materials being relatively energetic. That is, the materials may decompose exothermically, which may be desirable.

The pyrotechnic pellet 100 may also include an oxidator. The oxidator may be bound with the wood particles and the metal salt(s) by the binder. The overall amount of the oxidator included in the pyrotechnic pellet 100 may range from 1 wt % to 85 wt %. In some examples, the oxidator may be selected from a group consisting of ammonium nitrate (NH₄NO₃), ammonium perchlorate (NH₄ClO₄), barium nitrate (Ba(NO₃)₂), barium chlorate (Ba(ClO₃)₂), strontium nitrate (Sr(NO₃)₂), potassium nitrate (KNO₃), and potassium perchlorate (KClO₄). In some instances, an oxidator (or an oxidizing agent) may refer to any substance in a redox chemical reaction that gains (“accepts”, “receives”) an electron from a reducing agent. In other words, an oxidizer is any substance that oxidizes another substance, which may facilitate a chemical reaction such as burning or emitting colors.

The pyrotechnic pellet 100 may include one or more other materials, such as metal salts. As used herein, a metal salt may refer to a compound formed when the hydrogen of an acid is replaced by a metal. Such substances are often made by reacting metal compounds (e.g., oxides) with an acid. Different metal salts may, when ignited (e.g., burned) emit different colors. For example, Strontium-based compounds may emit red hues, Calcium-based compounds may emit orange hues, Sodium-based compounds may emit yellow hues, Barium-based compounds may emit green hues, Copper-based compounds may emit blue hues, and other compounds may emit purple, silver, white, or other colored hues.

The pyrotechnic pellet 100 may include between 2 wt % and 30 wt % metal salts. In some examples, the metal salts may include one or more of and may be selected from one of the following groups:
Strontium (Sr), Calcium (Ca), Sodium (Na), Barium (Ba), Copper (Cu), Rubidium (Rb), Aluminum (Al), Magnesium (Mg), Titanium (Ti), or Antimony (Sb); or
Strontium Nitrate (Sr(NO₃)₂), Strontium Carbonate (SrCO₃), Strontium Oxalate (SrC₂O₄), Strontium Sulfate (SrSO₄), or Strontium Chloride (SrCl₂); or
Calcium Carbonate (CaCO₃), Calcium Chloride (CaCl₂), Calcium Sulfate (CaSO₄), or hydrated Calcium Sulfate (CaSO₄(H₂O)ₓ); or
Sodium Bicarbonate (NaHCO₃), Sodium Carbonate (Na₂CO₃), Sodium Chloride (NaCl), Sodium Oxalate (Na₂C₂O₄), or Sodium Nitrate (NaNO₃); or
Barium Chloride (BaCl₂), Barium Chlorate (Ba(ClO₃)₂), Barium Carbonate (BaCO₃), Barium Nitrate (Ba(NO₃)₂), or Barium Oxalate (BaC₂O₄).

In some examples, the pyrotechnic pellet 100 may include a combination of one or more of the aforementioned metal salts.

In other examples, the metal salts may include one or more of:
Copper Chloride (CuCl), Copper Oxide (Cu₂O, CuO), Copper Carbonate (CuCO₃), Copper Oxychloride (3CuOCuCl₂), Copper Arsenite (Cu(CH₃COO)₂3Cu(AsO₂)₂), or Copper Sulfate (CuSO₄5H₂O); or
charcoal, Cryolite (Na₃AlF₆), or paris green (Cu(CH₃COO)₂3Cu(AsO₂)₂).

In some examples, the pyrotechnic pellet 100 may include a combination of one or more of the aforementioned metal salts.

Thus, the desired color for the pyrotechnic pellet 100 to emit (e.g., when ignited, burned) is dependent on the metal salt (or metal salts) included with the wood particles, the binder, and/or the oxidator.

In some examples, the pyrotechnic pellet 100 may be formed by forming wood particles. As described herein, the pyrotechnic pellet 100 may include food-grade or non-food-grade wood. To form the particles, wood (or another, similar fuel type) may be crushed or otherwise ground by a mill or other, similar machine. In some instances, it may be desirable to reduce the size of the wood particles to be relatively small. For example, it may be desirable to reduce the size of the wood particles to be 0.5 mm (0.2″) or less in length, diameter, or across.

In some instances, the wood particles may be dried after being formed (e.g., before being combined with the other materials included in the pyrotechnic pellet 100). It may be desirable to dry the wood particles until the wood particles have a moisture level (e.g., an average moisture level) is between 10% and 20%. After drying the wood particles, the particles may be processed, run through a sieve or other, similar apparatus to remove contaminants.

After forming and drying the wood particles, the wood particles may be combined or mixed with one or more metal salts and, in some example, an oxidator. As described herein, the metal salt (or the metal salts) may be selected based on a desired color for the pyrotechnic pellet 100 to emit (e.g., when ignited, burned). Additionally, or alternatively, the wood particles and metal salt(s) may be combined with a binder (and oxidator, if applicable), such as nitrocellulose. In other examples, the natural lignin sulfate of the wood particles may act as a binder. That is, a binder may be added to the wood particles and metal salt(s), or the binder may be a byproduct of the wood particles. In either instance, the wood and metal salt(s) may be bound together.

After combing the wood particles, metal salt(s), and optionally a binder and oxidator, the materials may be transferred to a pellet mill where the mixture is compressed into individual pellets. The pellet mill may heat the materials (e.g., to a temperature between 170° and 190° F.) to form the pyrotechnic pellets 100 as shown in FIG. 1. In some instances, if a binder is not added to the wood particles, metal salt(s), and/or oxidator, heating the wood particles may result in lignin sulfate being released from the wood particles, which may act as a natural binder. After the pyrotechnic pellets 100 are milled (e.g., formed), they may cool before being ignited (e.g., burned). The pyrotechnic pellets 100 can be ignited (e.g., burned) in a variety of settings, such as in a fireplace or in a fire pit, among other settings. When the pyrotechnic pellets 100 are burned, they may emit heat and a variety of colors, which may warm the associated environment, while advantageously enhancing its ambiance.

In some examples, the method steps described herein may be performed in a different order. That is, although described in a particular order, a pyrotechnic pellet 100 may be formed by performing the aforementioned steps in any suitable order.

In other examples (not shown), the pyrotechnic pellets 100 may be shaped or formed differently. For example, instead of being pelletized, the same or similar compounds can be combined into a log, briquettes, or wood chips. Additionally, or alternatively, the metal salt(s) may not be included in the pyrotechnic pellets 100, but may instead be made, such as ground (e.g., finely ground), into a dust or a powder that is used to coat the pyrotechnic pellets 100 (or the log, briquettes, or wood chips). In such instances, the pyrotechnic pellets 100, when ignited (e.g., burned) may emit heat and one or more colors as described herein. Lastly, in some examples, metal salts may be pelletized (or formed into a log, briquettes, or chips) separately or along with one or more other materials (other than wood), and these pellets may be mixed with wood pellets. Thus, when the mixture is ignited (e.g., burned), it may emit heat (e.g., from the wood pellets) and color (e.g., from the pelletized metal salt(s)), which may similarly warm the associated environment, while enhancing its ambiance.

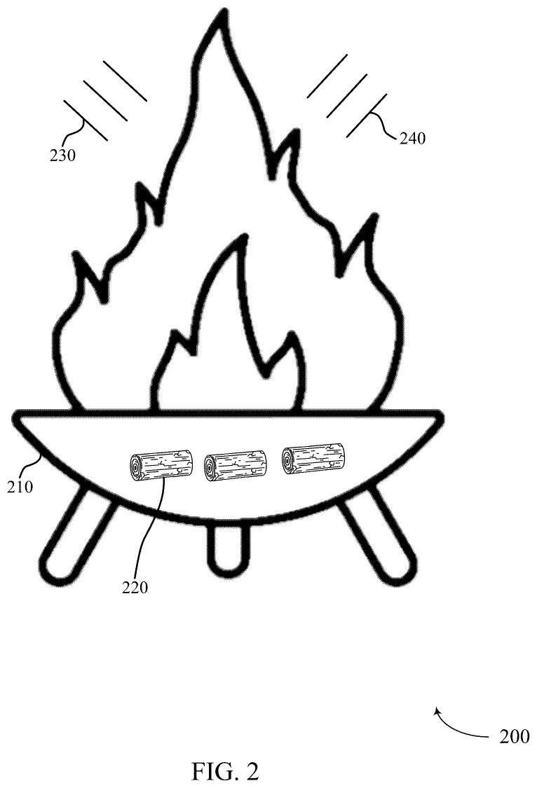

FIG. 2 illustrates an example of an environment 200 in which a pyrotechnic pellet may be used in accordance with examples as disclosed herein. In some instances, the environment 200 may include a fire pit 210 that includes one or more ignited (e.g., burning) pyrotechnic pellets 220, which may be examples of the pyrotechnic pellets 100 as described with reference to FIG. 1. As described herein, the pyrotechnic pellets 220 may include one or more metal salts that may cause the pyrotechnic pellets 220 to emit colors such as red, gold, green, blue, purple, silver, and white. Thus, the pyrotechnic pellets 220 may be capable of emitting both heat 230 and a variety of colors 240, which may warm the environment 200, while enhancing its ambiance.

As described with reference to FIG. 2, the environment 200 may include a fire pit 210. The fire pit 210 may be configured to receive (e.g., hold, store) one or more pyrotechnic pellets 220, and the pyrotechnic pellets 220 may be burned (e.g., ignited) while in the fire pit 210. In other examples, the fire pit 210 may represent any structure configured to receive burning pyrotechnic pellets 220, such as a stove, an oven, a campfire, a grill, or the like. That is, the pyrotechnic pellets 220 may be burned in any suitable structure.

As described herein, the pyrotechnic pellets 220, when burned, may emit heat 230 into the environment 200. The degree of the heat 230 (e.g., the relative hotness at which the pyrotechnic pellets 220 burn) may depend on a variety factors, one being the type of wood used as a fuel. In some cases, some fuels (e.g., some woods) may burn relatively hotter than others, thus emitting a higher degree of heat 230 into the environment.

Moreover, the pyrotechnic pellets 220, when burned, may emit one or more colors 240 into the environment 200. The specific color 240 (or colors 240) emitted by the pyrotechnic pellets 220 may depend on the type of metal salt (or metal salts) included in the pyrotechnic pellet 220. As described herein, the pyrotechnic pellets 220 may emit colors 240 such as red, gold, green, blue, purple, silver, and white, which may be different than the natural hues emitted when burning strictly wood products. Accordingly, when the pyrotechnic pellets 220 are burned, they may emit heat 230 and a variety of colors 240, which may warm the associated environment, while enhancing its ambiance relative to conventional wood fuels.

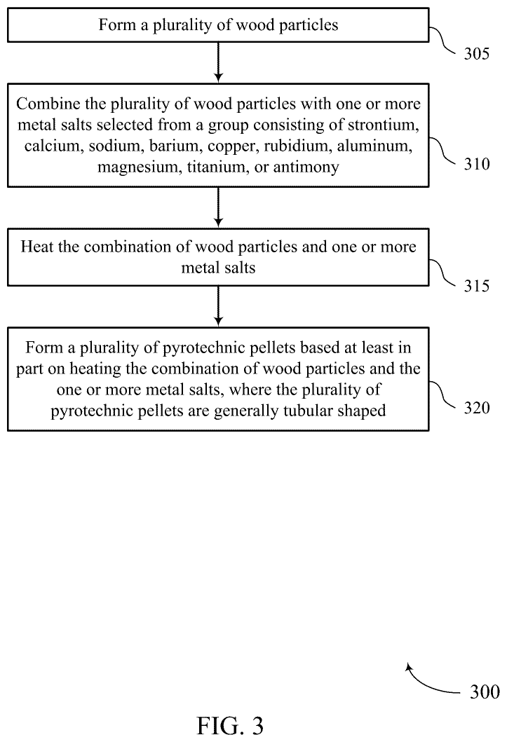

FIG. 3 shows a flowchart illustrating a method 300 that supports pyrotechnic colorant pellets in accordance with examples as disclosed herein. The operations of method 300 may be implemented by the method or components described herein.

At 305, the method may include forming a plurality of wood particles. In some examples, the wood particles may be formed by crushing or otherwise grinding (e.g., by a mill), a wood product such as a log. In some instances, it may be desirable to reduce the size of the wood particles to be relatively small. For example, it may be desirable to reduce the size of the wood particles to be 0.5 mm (0.2″) or less in length, diameter, or across.

At 310, the method may include combining the plurality of wood particles with one or more metal salts selected from a group consisting of strontium, calcium, sodium, barium, copper, rubidium, aluminum, magnesium, titanium, or antimony. In some examples, the ground wood particles may be mixed with a metal salt that is in the form of a dust or a powder.

At 315, the method may include heating the combination of wood particles and one or more metal salts. A device such as a pellet mill may heat the materials (e.g., to a temperature between 170° and 190° F.) to form the pyrotechnic pellets 100 as shown in FIG. 1.

At 320, the method may include forming a plurality of pyrotechnic pellets based at least in part on heating the combination of wood particles and the one or more metal salts, where the plurality of pyrotechnic pellets are generally tubular shaped. In some examples, instead of being pelletized, the same or similar compounds can be combined into a log, briquettes, or wood chips. Additionally, or alternatively, the metal salt(s) may not be included in the pyrotechnic pellets 100, but may instead be made, such as ground (e.g., finely ground), into a dust or a powder that is used to coat the pyrotechnic pellets (or the log, briquettes, or wood chips). In such instances, the pyrotechnic pellets, when ignited (e.g., burned) may emit heat and one or more colors as described herein.

In some examples, an apparatus as described herein may perform a method or methods, such as the method 300. The apparatus may include features, circuitry, logic, means, or instructions (e.g., a non-transitory computer-readable medium storing instructions executable by a processor), or any combination thereof for performing the following aspects of the present disclosure:
Aspect 1: A method or apparatus including operations, features, means, or any combination thereof for forming a plurality of wood particles; combining the plurality of wood particles with one or more metal salts selected from a group consisting of strontium, calcium, sodium, barium, copper, rubidium, aluminum, magnesium, titanium, or antimony; heating the combination of wood particles and one or more metal salts; and forming a plurality of pyrotechnic pellets based at least in part on heating the combination of wood particles and the one or more metal salts, where the plurality of pyrotechnic pellets are generally tubular shaped.
Aspect 2: The method or apparatus of aspect 1, further including operations, features, means, or any combination thereof for combining the plurality of wood particles and one or more metal salts with a binder including a starch or an oil, where the plurality of wood particles and the one or more metal salts are bound by the binder.
Aspect 3: The method or apparatus of any of aspects 1 through 2, where heating the combination of wood particles and the one or more metal salts generates lignin sulfate and the plurality of wood particles and the one or more metal salts are bound by the lignin sulfate.
Aspect 4: The method or apparatus of any of aspects 1 through 3, further including operations, features, means, or any combination thereof for combining the plurality of wood particles and one or more metal salts with an oxidator selected from a group consisting of ammonium nitrate, ammonium perchlorate, barium nitrate, barium chlorate, strontium nitrate, potassium nitrate and potassium perchlorate, where the plurality of pyrotechnic pellets include the oxidator.
Aspect 5: The method or apparatus of any of aspects 1 through 4, where the one or more metal salts include one or more of strontium nitrate, strontium carbonate, strontium oxalate, strontium sulfate, or strontium carbonate.
Aspect 6: The method or apparatus of any of aspects 1 through 5, where the one or more metal salts include one or more of calcium carbonate, calcium chloride, calcium sulfate, or hydrated calcium sulfate.
Aspect 7: The method or apparatus of any of aspects 1 through 6, where the one or more metal salts include one or more of sodium bicarbonate, sodium carbonate, sodium chloride, sodium oxalate, or sodium nitrate.

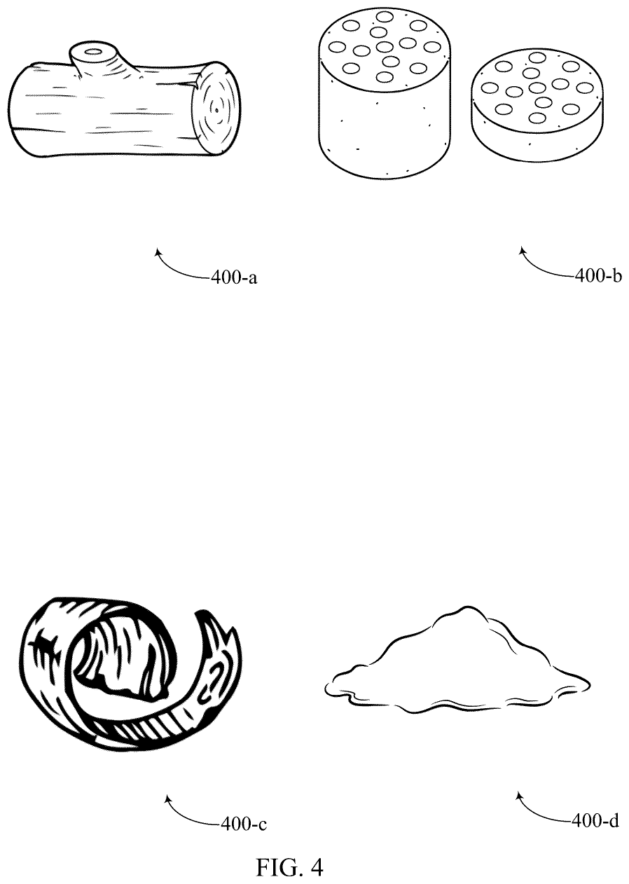

FIG. 4 illustrates alternative examples to pyrotechnic pellets in accordance with examples as disclosed herein. In some instances, FIG. 4 may illustrate a pyrotechnic log 400-a, pyrotechnic briquettes 400-b, a pyrotechnic wood chip 400-c, and pyrotechnic dust 400-d (e.g., pyrotechnic powder 400-d). the pyrotechnic log 400-a, the pyrotechnic briquettes 400-b, and the pyrotechnic wood chip 400-c may each include one or more metal salts. Further, the pyrotechnic dust 400-d (e.g., the pyrotechnic powder 400-d) may be or may include one or more metal salts that are used to coat a wood product, such as a pyrotechnic pellet 100 as described with reference to FIG. 1, or a pyrotechnic log 400-a, pyrotechnic briquette 400-b, or a pyrotechnic wood chip 400-c. As described herein, the metal salts may cause a wood product, when ignited (e.g., burned), colors such as red, gold, green, blue, purple, silver, and white. Thus, the pyrotechnic log 400-a, pyrotechnic briquettes 400-b, and pyrotechnic wood chip 400-c may be capable of emitting both heat and a variety of colors, which may warm the associated environment, while enhancing its ambiance.

In some examples, the pyrotechnic log 400-a may be similar to the pyrotechnic pellet 100 as described with reference to FIG. 1, but in log form. That is, the pyrotechnic log 400-a may include the same or similar materials and compounds as a pyrotechnic pellet 100, and may be formed in generally the same manner. However, the pyrotechnic log 400-a may be relatively larger than a pyrotechnic pellet 100, and thus may be designed for use in a fireplace or firepit, where it may be burned for relatively longer durations than a singular pellet.

In some examples, the pyrotechnic briquette 400-b may be similar to the pyrotechnic pellet 100 as described with reference to FIG. 1, but in briquette form. That is, the pyrotechnic briquette 400-a may include the same or similar materials and compounds as a pyrotechnic pellet 100, and may be formed in generally the same manner. However, the pyrotechnic briquette 400-a may be relatively larger than a pyrotechnic pellet 100, and thus may be designed for use in a fireplace, firepit, or other environment (such as a grill), where it may be burned for relatively longer durations than a singular pellet.

In some examples, the pyrotechnic wood chip 400-c may be similar to the pyrotechnic pellet 100 as described with reference to FIG. 1, but in chip (or shaving) form. That is, the pyrotechnic wood chip 400-c may include the same or similar materials and compounds as a pyrotechnic pellet 100, and may be formed in generally the same manner. However, the pyrotechnic wood chip 400-c may be relatively larger than a pyrotechnic pellet 100, and thus may be designed for use in a fireplace or firepit, where it may be burned for relatively longer durations than a singular pellet.

In some examples, the pyrotechnic dust 400-d may be a granularized, powder, or dust form of a metal salt. That is, the pyrotechnic dust 400-d may include the same or similar materials and compounds as the metal salts described herein, but may be formed as a dust or powder that is used to coat a wood product or briquette. For example, a wood pellet, log, briquette, or wood chip may be formed and subsequently coated by the pyrotechnic dust 400-d. Thus, when burned, the coated product may emit heat and a variety of colors, which may warm the associated environment, while enhancing its ambiance.

It should be noted that the aspects described herein describe possible implementations, and that the operations and the steps may be rearranged or otherwise modified and that other implementations are possible. Further, portions from two or more of the methods may be combined.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A pyrotechnic pellet, comprising:
a pyrotechnic fuel comprising wood particles;
a binder; and
one or more metal salts, wherein the pyrotechnic fuel and the one or more metal salts are bound by the binder, and wherein the pyrotechnic fuel, the binder, and the one or more metal salts are compressed into a generally tubular shape.

2. The pyrotechnic pellet of claim 1, further comprising:
an oxidator, wherein the pyrotechnic fuel, the oxidator, and the one or more metal salts are bound by the binder, and wherein the pyrotechnic fuel the oxidator, the binder, and the one or more metal salts are compressed into the generally tubular shape.

3. The pyrotechnic pellet of claim 2, wherein the oxidator is selected from a group consisting of ammonium nitrate, ammonium perchlorate, barium nitrate, barium chlorate, strontium nitrate, potassium nitrate and potassium perchlorate.

4. The pyrotechnic pellet of claim 1, wherein the one or more metal salts are selected from a group consisting of strontium, calcium, sodium, barium, copper, rubidium, aluminum, magnesium, titanium, or antimony.

5. The pyrotechnic pellet of claim 4, wherein the one or more metal salts comprise one or more of strontium nitrate, strontium carbonate, strontium oxalate, strontium sulfate, or strontium carbonate.

6. The pyrotechnic pellet of claim 4, wherein the one or more metal salts comprise one or more of calcium carbonate, calcium chloride, calcium sulfate, or hydrated calcium sulfate.

7. The pyrotechnic pellet of claim 4, wherein the one or more metal salts comprise one or more of sodium bicarbonate, sodium carbonate, sodium chloride, sodium oxalate, or sodium nitrate.

8. The pyrotechnic pellet of claim 4, wherein the one or more metal salts comprise one or more of barium chloride, barium chlorate, barium carbonate, barium nitrate, or barium oxalate.

9. The pyrotechnic pellet of claim 4, wherein the one or more metal salts comprise one or more of copper chloride, copper oxide, copper carbonate, copper oxychloride, copper arsenite, or copper sulfate.

10. The pyrotechnic pellet of claim 1, wherein the one or more metal salts comprise one or more of charcoal, cryolite, or paris green.

11. The pyrotechnic pellet of claim 1, wherein the binder comprises a starch, an oil, or lignin sulfate.

12. The pyrotechnic pellet of claim 1, wherein the generally tubular shape comprises a cylindrical shape.

13. A method, comprising:
forming a plurality of wood particles;
combining the plurality of wood particles with one or more metal salts selected from a group consisting of strontium, calcium, sodium, barium, copper, rubidium, aluminum, magnesium, titanium, or antimony;
heating the combination of wood particles and one or more metal salts; and
forming a plurality of pyrotechnic pellets based at least in part on heating the combination of wood particles and the one or more metal salts, wherein the plurality of pyrotechnic pellets are generally tubular shaped.

14. The method of claim 13, further comprising:
combining the plurality of wood particles and one or more metal salts with a binder comprising a starch or an oil, wherein the plurality of wood particles and the one or more metal salts are bound by the binder.

15. The method of claim 13, wherein heating the combination of wood particles and the one or more metal salts generates lignin sulfate, and wherein the plurality of wood particles and the one or more metal salts are bound by the lignin sulfate.

16. The method of claim 13, further comprising:
combining the plurality of wood particles and one or more metal salts with an oxidator selected from a group consisting of ammonium nitrate, ammonium perchlorate, barium nitrate, barium chlorate, strontium nitrate, potassium nitrate and potassium perchlorate, wherein the plurality of pyrotechnic pellets comprise the oxidator.

17. The method of claim 13, wherein the one or more metal salts comprise one or more of strontium nitrate, strontium carbonate, strontium oxalate, strontium sulfate, or strontium carbonate.

18. The method of claim 13, wherein the one or more metal salts comprise one or more of calcium carbonate, calcium chloride, calcium sulfate, or hydrated calcium sulfate.

19. The method of claim 13, wherein the one or more metal salts comprise one or more of sodium bicarbonate, sodium carbonate, sodium chloride, sodium oxalate, or sodium nitrate.

20. A pyrotechnic pellet, comprising:
an oxidator selected from a group consisting of ammonium nitrate, ammonium perchlorate, barium nitrate, barium chlorate, strontium nitrate, potassium nitrate and potassium perchlorate; and
one or more metal salts selected from a group consisting of strontium, calcium, sodium, barium, copper, rubidium, aluminum, magnesium, titanium, or antimony, wherein the oxidator and the one or more metal salts are formed into a generally tubular shape.
